(19) United States
(12) Patent Application Publication
(10) Pub. No.: US 2006/0067829 A1
(43) Pub. Date: Mar. 30, 2006

(54) Backswept titanium turbocharger compressor wheel

(76) Inventors: Gary D. Vrbas, Wilmington, CA (US); Ronren Gu, Cypress, CA (US)

Correspondence Address: HONEYWELL TURBO TECHNOLOGIES, 23326 HAWTHORNE BOULEVARD, SUITE #200, TORRANCE, CA, 90505, US

(21) Appl. No.: 11/232,391

(22) Filed: Sep. 21, 2005

Related U.S. Application Data
(60) Provisional application No. 60/612,706, filed on Sep. 24, 2004.

(51) Int. Cl. B64C 27/46

(52) U.S. Cl. 416/223 R

(57) ABSTRACT

The present invention provides a high efficiency compressor wheel with highly backswept blades, such that the wheel provides optimal efficiency over a wide operating range. The compressor wheel is made of titanium, which provides for an acceptably thin blade thickness while providing a backsweep of more than 50° and improves the aerodynamic flow characteristics within the compressor wheel's flow channels. By providing stable operation at both lower and higher flows allows a compressor to provide stable flow over a wider range of engine operating conditions, thereby accommodating higher engine speeds, torques and boost levels. The internal flow characteristics provided for by the present invention also reduces efficiency losses associated with flow separation and recirculation, which results in improved compressor efficiency.

### CROSS-REFERENCE TO RELATED APPLICATIONS

This application claims the benefit of the filing of U.S. Provisional Patent Application Ser. No. 60/612,706, entitled “Backswept Titanium Turbocharger Compressor Wheel”, filed on Sep. 24, 2004, and the specification of that application is incorporated herein by reference.

### BACKGROUND OF THE INVENTION

1. Field of the Invention (Technical Field)

The present invention relates to a high-efficiency turborcharger compressor wheel comprising titanium, a titanium alloy, or a combination thereof, the wheel having a high degree of blade backsweep and thereby providing stable operation over a wide range of flow conditions.

2. Description of Related Art

Turbochargers for gasoline and diesel internal combustion engines are known in the art for pressurizing or boosting the intake air stream, or mixed air and exhaust stream, that is routed to a combustion chamber of the engine, by using the heat and volumetric flow of exhaust gas exiting the engine. Specifically, the exhaust gas exiting the engine is routed into a turbine housing of a turbocharger in a manner that causes an exhaust gas-driven turbine to spin within the housing.

The exhaust gas-driven turbine is mounted onto one end of a shaft that is common to a radial air compressor wheel or impeller mounted onto an opposite end of the shaft. Thus, rotary action of the turbine also causes the air compressor wheel to spin within a compressor housing of the turbocharger that is separate from the turbine housing. The spinning action of the air compressor wheel causes intake air, or mixed intake air and exhaust, to enter the compressor housing and to be pressurized or boosted to a desired amount before it is mixed with fuel and combusted within the engine combustion chambers.

The blades of the compressor wheel are designed to draw a fluid; such as air or mixed air and exhaust, axially into the compressor housing, to boost or pressurize the fluid by the centrifugal acceleration of the wheel, and to discharge the pressurized fluid, generally in a radially outward direction. Typically, the pressurized fluid is discharged into a volute chamber forming a part of the compressor housing.

The design of the blades of the compressor wheel has a significant impact on functionality. For many applications, it is desirable that the compressor wheel provide stable operation over a wide flow range, from surge, which places a low limit on low flow operation, to choke, which places a limit on high flow operation. The need for stable operation over a wide flow range is becoming increasingly important because of designs that have been increasing engine speed, torque, and boost level, the latter being the result of more stringent emission regulations. Additionally, the design of the blades of the compressor wheel affects compressor thermodynamic efficiency, with high thermodynamic efficiency leading to lower engine fuel consumption and reduced emissions.

Compressor wheels with backswept blades are known in the art. However, conventional aluminum compressor wheels have blades with a backsweep angle of less than 40°, and typically less than approximately 20° for high pressure applications. The material stress limitations of aluminum and aluminum alloy compressor wheels limits the degree of feasible backsweep of compressor wheels that operate at high speeds. The blade thickness in aluminum and aluminum alloy blades generally increases with backsweep, given that high backsweep typically causes high stresses, particularly near the wheel outlet, or exducer, area. At any backsweep angle of greater than approximately 40°, and typically greater than approximately 20°, the required blade thickness for operation at high speeds is too thick to provide for efficient operation.

Although compressor wheels or blades made of titanium or titanium alloys are known in the art as disclosed in U.S. Pat. No. 6,588,485, No. 6,629,556, No. 6,663,347, and No. 6,754,954, the prior art does not provide for compressor wheels or blades comprising a high degree of blade backsweep greater than approximately 40°.

There is thus a need for high-speed compressor wheels with blades with a particularly high degree of backsweep, which can provide high efficiency operation over a wide flow range. It is against this need that the invention is made.

### BRIEF SUMMARY OF THE INVENTION

In one embodiment, the present invention provides a compressor wheel for a turbocharger, the compressor wheel made of titanium or titanium alloys and having a plurality of blades symmetrically arrayed about a hub, each blade comprising a leading edge, a shroud edge, and a trailing edge, wherein the blade angle varies from the leading edge to the trailing edge with an average blade angle at the trailing edge of at least approximately 50°. In another embodiment, the average blade angle at the trailing edge is at least approximately 55°, and in still another embodiment, at least approximately 60°. In yet another embodiment, the blade angle continuously varies from the leading edge to the trailing edge.

The plurality of blades in the compressor wheel typically includes, but is not limited to, approximately 8 to 18 blades. In another embodiment, the compressor wheel comprises a splittered wheel, wherein certain blades, such as every other blade, are partial blades, and the remaining blades are full blades.

In one embodiment, the diameter of the compressor wheel is less than approximately 90 mm and the maximum thickness of each blade is less than approximately 0.145 inches. In this and other embodiments, the compressor wheel is preferably a high pressure compressor wheel, providing a boost relative to atmospheric pressure of at least approximately 4 to 1, and preferably at least approximately 4.4 to 1. In this and other embodiments, the compressor wheel is preferably a high speed compressor wheel designed to operate at tip speeds of at least approximately 1,900 feet per second while providing acceptable mechanical stress limits to provide a suitable low cycle fatigue.

In one embodiment of the present invention, the blade angle of the shroud streamline at the leading edge is greater than the blade angle of the shroud streamline at the trailing edge. In another embodiment, the blade angle of the shroud line at one or more intermediate points between the leading edge and the trailing edge is less than the blade angle of the shroud streamline at either the leading edge or the trailing edge.

The compressor wheel and blades are preferably made of titanium (Ti), a titanium alloy, or a combination thereof. Suitable titanium alloys provide high stress limits that provide acceptable low cycle fatigue, and such alloys are known to those skilled in the art. In one embodiment, for example, the titanium alloy contains approximately 90% Ti by weight, less than approximately 10% of aluminum and/or vanadium, and less than approximately 1% each of other elements, such as, for example, iron and/or oxygen. However, other titanium alloys may be employed with this invention.

One advantage of the present invention is that with Ti or Ti alloys it is possible to design the compressor wheel to stress levels or limits that allow the compressor wheel to operate at high pressure levels or high tip speeds, or both, without mechanical stress limits. In general, this permits the blade thickness to be substantially decreased in comparison to what is effectively possible using aluminum and other metals or alloys with lower stress limits, and further permits the design and fabrication of a compressor wheel that provides for high pressure levels and high tip speeds required by modern combustion engine turbocharger systems.

Therefore, another embodiment of the present invention provides for a method to provide stable flow over a range of engine operating conditions to reach high engine speeds, torques, and boost levels, the method comprising providing a compressor wheel for a turbocharger, the compressor wheel comprising a plurality of blades made of a metal comprising titanium, the blades symmetrically arrayed about a hub, each blade comprising a leading edge, a shroud edge, and a trailing edge, and wherein an angle of each blade varies from the leading edge to the trailing edge with an average blade angle at the trailing edge of at least approximately 50°, and operating the compressor wheel to provide a stable flow over the range of engine operating conditions that is greater than a range of engine operating conditions to which blades having an average blade angle at the trailing edge of less than approximately 50°, and even less than 40° are applied. The method may further comprise operating the compressor wheel to provide a boost relative to atmospheric pressure of at least approximately 4 to 1 and may further comprise operating the compressor wheel at a tip speed of at least approximately 1,900 feet per second.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a top view of an aluminum or aluminum alloy compressor wheel of the prior art with an approximately 30° backswept blade;

FIG. 2 is a side view of an aluminum or aluminum alloy compressor wheel of the prior art with an approximately 30° backswept blade;

FIG. 3 is a three-quarter view of a titanium compressor wheel of the present invention with an approximately 50° backswept blade;

FIG. 4 is a view of a blade of a titanium compressor wheel of the present invention with an approximately 50° backsweep and showing 6 plot lines through the blade;

FIG. 5 is a plot of blade thickness distribution of an 88 mm aluminum or aluminum alloy compressor wheel of the prior art;

FIG. 6 is a top view of a titanium compressor wheel of the present invention with an approximately 50° backswept blade;

FIG. 7 is a plot of blade angle distribution of an aluminum or aluminum alloy compressor wheel of the prior art with an approximately 17.5° backswept blade;

FIG. 8 is a plot of blade angle distribution of a titanium compressor wheel of the present invention with an approximately 50° backswept blade; and

FIG. 9 is a plot of blade thickness distribution of an 88 mm titanium compressor wheel of the present invention.

### DETAILED DESCRIPTION OF THE INVENTION

An embodiment of the present invention provides a high efficiency compressor wheel with highly backswept blades, such that the wheel provides optimal engine efficiency over a wide operating range. The compressor wheel is made of titanium, which provides for an acceptably thin blade thickness while providing a backsweep of more than 50°. The features of the compressor blade shape design improve the aerodynamic flow characteristics within the compressor wheel's flow channels. The improvement in flow characteristics provides more stable flow at low flows, and further allows the compressor to operate at higher choke flows than is possible with conventionally designed compressors, such as aluminum or aluminum alloy compressor wheels with a backsweep of less than 40°. The ability to provide stable operation at both lower and higher flows allows a compressor to provide stable flow over a wider range of engine operating conditions, thereby accommodating higher engine speeds, torques and boost levels. The improvement in internal flow characteristics also reduces efficiency losses, such as incidence loss, associated with flow separation and recirculation, which results in improved compressor efficiency.

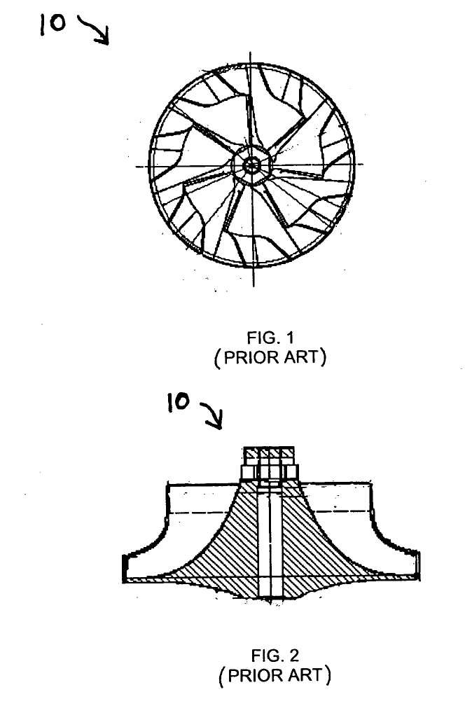

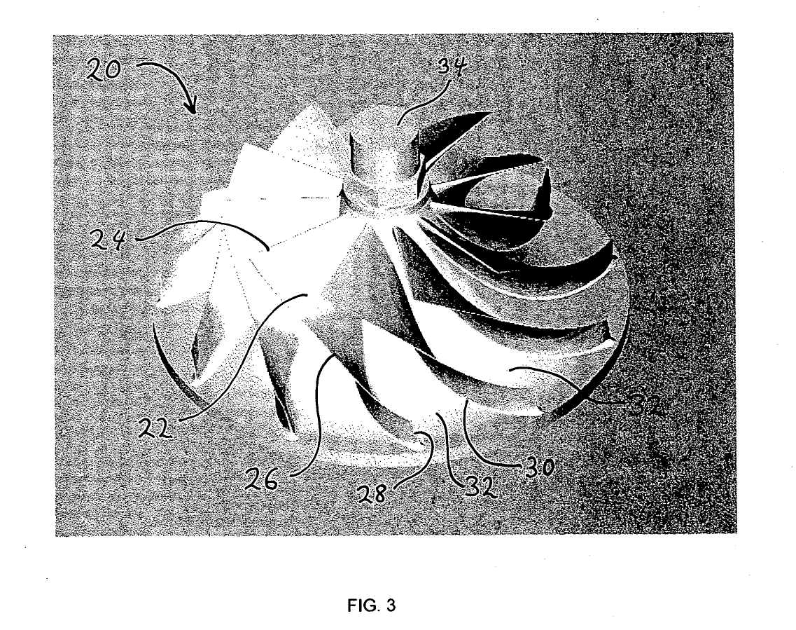

Conventional aluminum or aluminum alloy compressor wheels with backswept blades have a backsweep of less than about 40°, and in most instances of less than about 20° for high pressure applications. Conventional aluminum or aluminum alloy compressor wheels 10 are shown in FIG. 1 (top view) and FIG. 2 (side view). The parts of a compressor wheel are shown in FIG. 3, where titanium compressor wheel 20 includes center axial nose 34 and a plurality of blades 22 equally spaced on hub surface 32. Each blade 22 includes a leading edge 24, a hub line 30, defining the joinder of blade 22 to hub surface 32, a shroud edge 26, defining the outermost edge of the blade measured from hub surface 32, and a trailing edge 28, defining the most distant blade aspect from an axial line through center axial nose 34.

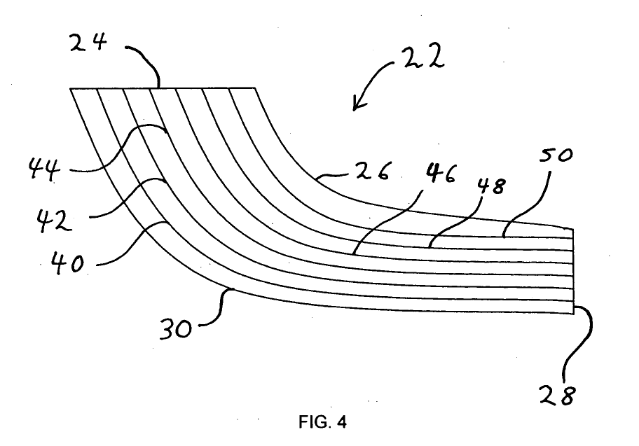

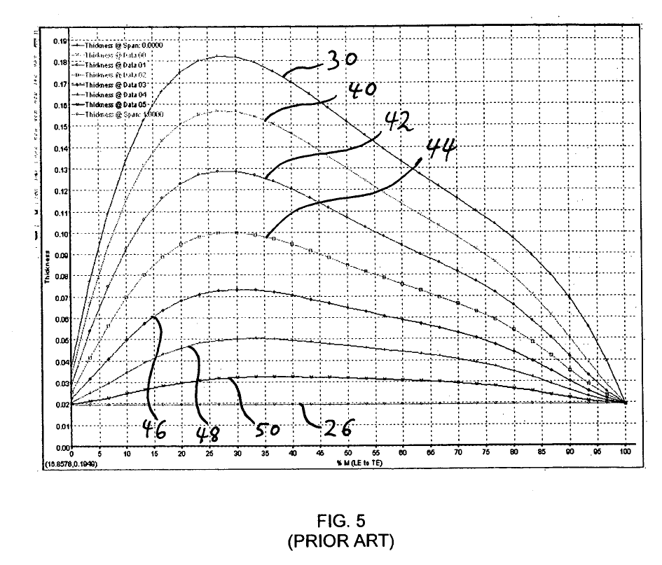

The blades 22 of compressor wheel 20, and generally any blades of compressor wheels, have a defined thickness and a defined blade angle at each point along the blade. FIG. 4 shows blade 22, which includes leading edge 24, hub streamline 30, shroud streamline 26, trailing edge 28, and six distinct streamlines 40, 42, 44, 46, 48, and 50, where each streamline is equidistant to the adjacent streamline, (or in the case of streamline 40, is equidistant to hub streamline 30 and streamline 42, and in the case of streamline 50, is equidistant to streamline 48 and shroud streamline 26), such equidistance being determined, for each point along the streamline, at a line approximately perpendicular to hub streamline 30.

With respect to blade thickness, FIG. 5 shows the blade thickness distribution of an 88 mm aluminum or aluminum alloy compressor wheel of the prior art, which is a 48 trim wheel (where trim is defined as the square of the ratio of the inlet diameter to the tip diameter times 100). The bottommost line is the thickness of the blade along shroud streamline 26; it may thus be seen that the blade thickness along shroud streamline 26 is uniform. The topmost line is hub streamline 30; it may be seen that the greatest thickness is along the hub streamline, where blade 22 is joined to hub surface 32. Again with respect to FIG. 5, it may be seen that the topmost line, representing the thickness of hub streamline 30, continuously varies from the leading edge to the trailing edge, reaching a greatest thickness at between about 25% to 30% of the distance from the leading edge to the trailing edge. Thus, the thickness along hub streamline 30 varies from a minimum of 0.02 inches at the trailing edge 28 to a maximum of about 0.18 inches at between about 25% to 30% of the distance from the leading edge to the trailing edge. The remaining lines plotted in FIG. 5 correspond to the streamlines 40, 42, 44, 46, 48, and 50. For example, the line immediately up from the bottom line corresponds to streamline 50; it may be seen that at 0% M, at the leading edge, the thickness is approximately that of shroud streamline 26, and as the percentage distance proceeds from the leading edge (0% M) to the trailing edge (100% M), the thickness varies, reaching a maximum thickness at about 35% to 40% of the distance from the leading edge to the trailing edge. The next five plot lines up correspond, respectively, to streamlines 48, 46, 44, 42, and 40.

The blade angle at any point may be defined by the formula:
Blade Angle=r*dθ/dM
where r is the radius, d represents a first derivative, θ is the polar angle with respect to an arbitrary datum, and M is meridianal distance from the blade leading edge to the trailing edge along a the streamline.

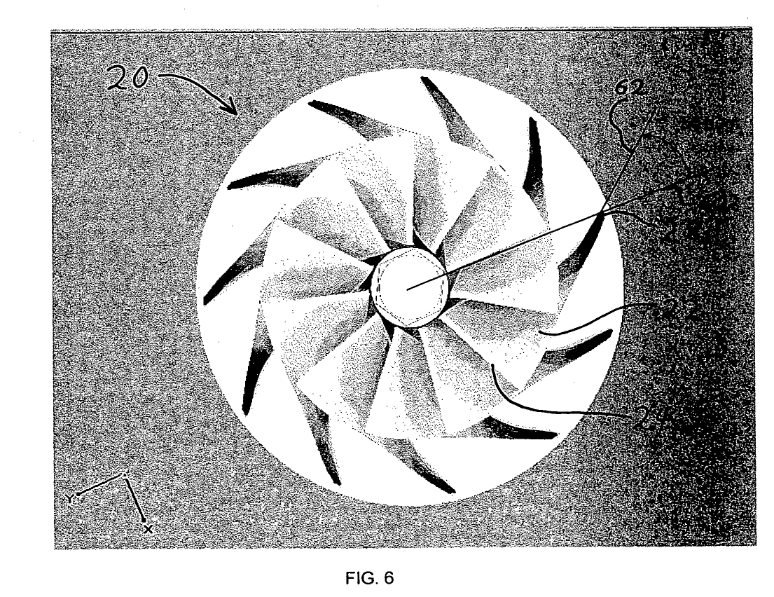

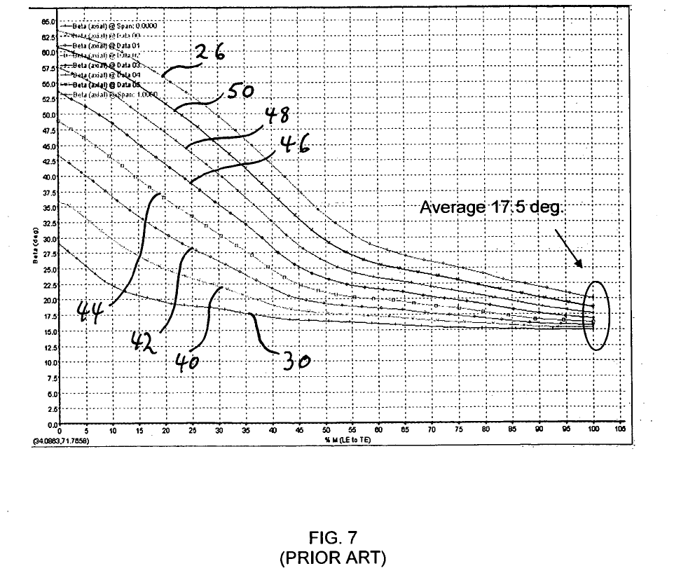

The “backsweep” is defined as the blade angle at the trailing edge, such as at trailing edge 28. Graphically, this may be depicted by reference to FIG. 6, which depicts a titanium compressor wheel of the present invention with an approximately 50° backswept blade. The approximately 50° blade angle at the trailing edge 28 is defined as the angle between radial line 60 and extension 62 of the average blade direction at trailing edge 28. Because blade 20 may vary in three dimensions, it may be seen that the extension 62 is not necessarily uniform along the height of trailing edge 28, and thus an average blade direction is provided. However, by means of the blade angle formula, the blade angle may be calculated at each point from the leading edge 24 to the trailing edge 28 along streamlines, such as streamlines 40, 42, 44, 46, 48, and 50. Thus FIG. 7 shows the blade angle distribution of an aluminum or aluminum alloy compressor wheel of the prior art along the hub streamline 30, from the leading edge (0% M) to the trailing edge (100% M) at multiple points, and similarly shows the blade angle distribution at multiple points along each of streamlines 40, 42, 44, 46, 48, and 50 and shroud streamline 26. The “backsweep” is thus the average of the blade angle distribution at 100% M, representing the trailing edge 28, shown in FIG. 7 as an average 17.5° backsweep. It is to be observed that each line shown in FIG. 7, and particularly the shroud streamline 26, shows a continuously decreasing blade angle from the leading edge to the trailing edge.

In a preferred embodiment, the invention makes use of the improved material properties of titanium or titanium alloys. Heretofore, blade shape designs which were fabricated from either cast or forged aluminum alloys were considerably constrained due to material stress limitations of aluminum. With respect to prior art titanium compressor wheels, those wheels had, for example, thinner blade thicknesses due to the higher stress limits of titanium, but were not otherwise designed or fabricated to provide improved efficiency, and did not employ the blade shape designs of the present invention. The design constraints are considerably less severe for blades fabricated from either cast or forged titanium or titanium alloys, in large part because of the considerable higher stress limits of titanium and titanium alloys, as compared to aluminum or aluminum alloys, for a given predicted life/duty cycle. Even considering the increased density of titanium compared to aluminum, key design features that can be achieved with titanium and titanium alloys include, but are not limited to, a significant increase in impeller blade backsweep or backward curvature, the use of non-radial blade elements in the leading edge and/or inducer section of the wheel, and the use of blades with reduced blade thickness. Increased backsweep reduces the wheel exit Mach number and reduces aerodynamic blade loading. These improve flow stability, delay the onset of surge, and therefore increase flow range. By providing blades which incorporate non-radial blade elements, it is possible to minimize flow losses associated with the incidence angle at the leading edge of the blades, which contributes to increased flow range and efficiency. The ability to design blades with reduced thickness also allows for larger inducer throat size and reduces mixing losses at the wheel exit, thus increasing choke flow capacity and improving efficiency.

Therefore, although FIGS. 4 and 6 depict a titanium alloy compressor wheel with radial blade elements, another embodiment comprises non-radial blade elements. Such blade elements may be bowed or may be inverse bowed. Therefore, in another embodiment, the leading edge defines, or is defined by, a non-radial line, such as a convex or concave line. Making non-radial blade elements, particularly for high pressure compressor wheels, is feasible with a high stress material such as titanium or titanium alloys, because generally, non-radial design elements, such as bowed blades, increase stress levels thereby making aluminum and aluminum alloys unsuitable for this purpose.

FIG. 6 depicts a titanium alloy compressor wheel of an embodiment of the present invention, wherein the backsweep, defined as the average blade angle at the trailing edge, is approximately 50°. However, the backsweep may vary in different embodiments of the present invention from a backsweep greater than approximately 50°. For example, the backsweep may be approximately 55°, 60°, 65°, or more, and all values therebetween.

FIG. 3 depicts a three-quarter view of a titanium alloy compressor wheel of an embodiment of the present invention with an approximately 50° backswept blade. The compressor wheel of FIGS. 4 and 6 may be dimensioned as appropriate for the turbocharger. The turbocharger size in turn is generally a function of the size and operating parameters of the gasoline or diesel internal combustion engine for which the compressor wheel is intended. In one embodiment, for example, the titanium alloy compressor wheel of FIGS. 4 and 6 has a diameter of approximately about 88 mm.

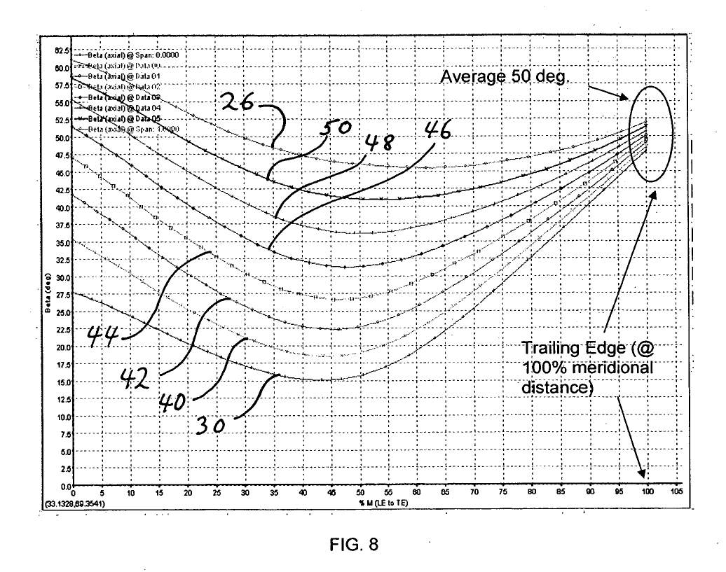

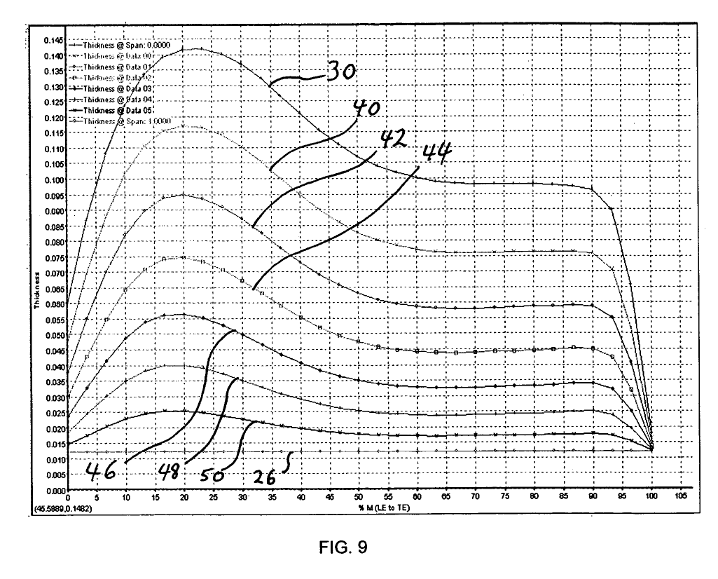

The invention is further illustrated by FIG. 8 which depicts the blade angle distribution of a titanium alloy compressor wheel of the present invention with an approximately 50° backswept blade, and by FIG. 9 which depicts a blade thickness distribution of an 88 mm titanium alloy compressor wheel as shown in FIGS. 4 and 6. Therefore, FIG. 8 shows the blade angle distribution of a titanium compressor wheel of an embodiment of the present invention along the hub streamline 30 from the leading edge (0% M) to the trailing edge (100% M) at multiple points, and similarly shows the blade angle distribution at multiple points along each of shroud streamlines 40, 42, 44, 46, 48, and 50 and shroud streamline 26. The “backsweep”, blade angle of the present invention is therefore the average of the blade angle distribution at 100% M, representing the trailing edge 28. In FIG. 8, that average is approximately 50°. Each line shown in FIG. 8, particularly shroud streamline 26, shows a curve, with the blade angle greater at each of the leading edge and trailing edge than the blade angle at one or more points between the leading edge and the trailing edge. Therefore, as shown in FIG. 8, the blade angle at the leading edge (0% M) for shroud streamline 26 is between 60° and 62.5°, decreases at about 60% to 65% of the distance from the leading edge to the trailing edge to a minimum less than approximately 47.5° and approaching 45°, then increases again at the trailing edge to a maximum of more than 50° and approaching 52.5°. Therefore, in one embodiment, the change of blade angle along the blade in a compressor wheel (e.g., as that depicted in FIG. 8) is different , as shown in FIG. 8, from the change of blade angle along the blade of an aluminum or aluminum alloy compressor wheel of the prior art (e.g., as that depicted in FIG. 7).

As is shown in FIG. 9, the blade thickness profile distribution of an 88 mm titanium compressor wheel, such as of hose depicted in FIGS. 4 and 6, is distinctly different from the blade thickness distribution of a prior art 88 mm aluminum or aluminum alloy compressor as that depicted in FIG. 5.

With respect to the fabrication of the compressor wheel, the blades or the blades and other parts of the compressor wheel are preferably made of titanium (Ti), a titanium alloy, or a combination of titanium for some parts of the compressor wheel and a titanium alloy for other parts. Suitable titanium alloys provide high stress limits that provide acceptable low cycle fatigue, and such alloys are known to those skilled in the art. In one embodiment, for example, the titanium alloy contains approximately 90% Ti by weight, less than approximately 10% of aluminum and/or vanadium, and less than approximately 1% each of other elements, such as, for example, iron or oxygen. However, other titanium alloys may be employed with this invention.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A turbocharger compressor wheel comprising:
a plurality of blades symmetrically arrayed about a hub, each said blade comprising a leading edge, a shroud edge, and a trailing edge;
wherein an angle of each said blade varies from said leading edge to said trailing edge with an average blade angle at said trailing edge of at least approximately 50°; and
wherein said compressor wheel blades are made of a metal comprising titanium.

2. The compressor wheel of claim 1 wherein said average blade angle at said trailing edge is at least approximately 55°.

3. The compressor wheel of claim 1 wherein said average blade angle at said trailing edge is at least approximately 60°.

4. The compressor wheel of claim 1 wherein said blade angle continuously varies from said leading edge to said trailing edge.

5. The compressor wheel of claim 1 wherein said metal comprises:
approximately 90% Ti by weight; and
less than approximately 10% of a metal selected from the group consisting of aluminum, vanadium, and a combination thereof.

6. The compressor wheel of claim 1 wherein a first group of said blades are partial blades and a second group of said blades are full blades so that said compressor wheel is a splittered wheel and wherein at least each of said full blades comprise an average blade angle at said trailing edge of at least approximately 50°.

7. The compressor wheel of claim 1 wherein said plurality of blades comprises from 8 to 18 blades.

8. The compressor wheel of claim 1 comprising a high pressure compressor wheel for providing a boost relative to atmospheric pressure of at least approximately 4 to 1.

9. The compressor wheel of claim 1 comprising a high pressure compressor wheel for providing a boost relative to atmospheric pressure of at least approximately 4.4 to 1.

10. The compressor wheel of claim 1 comprising a high speed compressor wheel for operating at tip speeds of at least approximately 1,900 feet per second.

11. The compressor wheel of claim 1 wherein a blade angle of said shroud streamline at said leading edge is greater than said blade angle of said shroud streamline at said trailing edge.

12. The compressor wheel of claim 1 wherein a blade angle of said shroud line at one or more intermediate points between said leading edge and said trailing edge is less than a blade angle of said shroud streamline at either said leading edge or said trailing edge.

13. A method for providing a stable aerodynamic flow over a range of engine operating conditions to reach high engine speeds, torques, and boost levels, the method comprising:
providing a compressor wheel for a turbocharger, the compressor wheel comprising:
a plurality of blades made of a metal comprising titanium, the blades symmetrically arrayed about a hub, each blade comprising a leading edge, a shroud edge, and a trailing edge; and
wherein an angle of each blade varies from the leading edge to the trailing edge with an average blade angle at the trailing edge of at least approximately 50°.

14. The method of claim 13 further comprising operating the compressor wheel to provide a stable flow over the range of engine operating conditions that is greater than a range of engine operating conditions to which blades having an average blade angle at the trailing edge of less than approximately 40° are applied.

15. The method of claim 13 further comprising operating the compressor wheel to provide a boost relative to atmospheric pressure of at least approximately 4 to 1.

16. The method of claim 13 further comprising operating the compressor wheel at a tip speed of at least approximately 1,900 feet per second.
